(19) United States
(12) Patent Application Publication
(10) Pub. No.: US 2026/0138125 A1
(43) Pub. Date: May 21, 2026

(54) SHAPED CATALYST BODY FOR MANUFACTURING SYNTHETIC GAS, METHOD FOR MANUFACTURING SHAPED CATALYST BODY, AND METHOD FOR MANUFACTURING SYNTHETIC GAS USING SHAPED CATALYST BODY

(71) Applicants: HYUNDAI MOTOR COMPANY, Seoul (KR); Kia Corporation, Seoul (KR)

(72) Inventors: Haeun JEONG, Hwaseong-si (KR); Jungyeon PARK, Hwaseong-si (KR); Ji-Hoon JANG, Hwaseong-si (KR); Dae Woong KIM, Hwaseong-si (KR); Woong Pyo HONG, Hwaseong-si (KR); Pyung Soon KIM, Hwaseong-si (KR)

(21) Appl. No.: 19/194,194

(22) Filed: Apr. 30, 2025

(30) Foreign Application Priority Data
Nov. 18, 2024 (KR) 10-2024-0163926

(51) Int. Cl. B01J 37/02; B01J 21/04; B01J 23/755; B01J 35/30; B01J 35/37; B01J 35/45; B01J 35/55; B01J 35/61; B01J 35/64; B01J 37/08; C01B 3/40

(52) U.S. Cl. CPC B01J 37/0244; B01J 21/04; B01J 23/755; B01J 35/37; B01J 35/393; B01J 35/394; B01J 35/395; B01J 35/45; B01J 35/55; B01J 35/612; B01J 35/647; B01J 35/651; B01J 37/0228; B01J 37/08; C01B 3/40; C01B 2203/0233; C01B 2203/0238; C01B 2203/1005; C01B 2203/1058; C01B 2203/1082; C01B 2203/1241

(57) ABSTRACT

A shaped catalyst body for manufacturing a synthetic gas includes a shaped carrier body, metal active particles supported on the shaped carrier body, and a metal oxide coating layer disposed on at least a portion of the metal active particles and the shaped carrier body. An average particle diameter of the metal active particles is 5 to 30 nm.

### CROSS-REFERENCE TO RELATED APPLICATION

This application claims priority to and the benefit of Korean Patent Application No. 10-2024-0163926, filed in the Korean Intellectual Property Office, on Nov. 18, 2024, the entire contents of which are incorporated herein by reference.

### TECHNICAL FIELD

The present disclosure relates to a shaped catalyst body for manufacturing a synthetic gas, a method for manufacturing the shaped catalyst body, and a method for manufacturing a synthetic gas using the shaped catalyst body.

### BACKGROUND

Gases including hydrogen and carbon monoxide are used in the automotive industry for supplying hydrogen used in fuel cells, in the steel industry for use in iron ore reduction, in the chemical industry for ammonia, methanol, and Fischer-Tropsch synthesis and manufacturing other chemicals, and the like.

In order to produce such gas, synthetic gas is produced from hydrocarbons through a reforming process, using catalysts made of nickel-based alumina or ruthenium-based alumina.

For instance, in a reforming process of the related art, a pellet-type catalyst may be charged into a reactor. Pellets are often manufactured by extrusion molding and can be manufactured into desired shapes such as spherical, cylindrical, and pellets with multiple holes.

In some cases, pellet catalysts may be broken into fragments due to various types of damage, such as damage caused by mechanical impact when loaded into a reactor, damage from thermal expansion and contraction during a temperature rise to a reforming reaction temperature and shutdown after a reaction, and damage caused by coke formation.

Small fragments resulting from such phenomena may fill gaps between the pellet catalysts and also accumulate at the bottom of the reactor, potentially causing flow resistance to a reformed gas and reducing the activity of the catalyst. For these reasons, a strength of the pellets is considered when manufacturing pellet catalysts.

Performance and durability of catalysts for manufacturing a synthetic gas may be considered for industrial operation. In some cases, a wet stirring method may be used to provide metal nanoparticles supported on a mesoporous support and to coat the support and the metal nanoparticles with a metal oxide.

In some cases, the strength of a shaped body may be reduced during the supporting and coating processes, and the metal nanoparticles may not be sufficiently supported due to a small specific surface area of the shaped body, resulting in a reduction in catalyst performance.

### SUMMARY

The present disclosure describes a shaped catalyst body for manufacturing a synthetic gas capable of simultaneously securing formability, crushing strength, and catalyst performance.

According to one aspect of the subject matter described in this application, a shaped catalyst body for manufacturing a synthetic gas includes a shaped carrier (support) body, metal active particles supported on the shaped carrier body, and a metal oxide coating layer disposed on at least a portion of (i) the metal active particles and (ii) the shaped carrier body, where an average particle diameter of the metal active particles is 5 to 30 nm.

Implementations according to this aspect can include one or more of the following features. For example, the shaped carrier body may include alumina and boehmite. In some examples, the metal active particles may include one or more of nickel (Ni), cobalt (Co), rhodium (Rh), ruthenium (Ru), iridium (Ir), palladium (Pd), platinum (Pt), gold (Au), and iron (Fe). In some examples, the metal oxide coating layer may include a metal component of the shaped carrier body and a metal component of the metal active particles. In some examples, the metal oxide coating layer may include one or more of alumina (Al₂O₃), magnesium aluminate (MgAl₂O₄), calcium aluminate (CaAl₂O₄), and nickel aluminate (NiAl₂O₄). In some examples, an average thickness of the metal oxide coating layer may be 2 to 10 nm.

In some implementations, a metal component of the metal active particles may be 0.1 to 2 wt % relative to a total 100 wt % of the shaped catalyst body, which includes the shaped carrier body, the metal active particles, and the metal oxide coating layer. In some examples, a specific surface area of the shaped catalyst body may be 0.1 to 30 m²/g, an average pore diameter may be 40 to 200 nm, and a porosity may be 40 to 90%.

In some examples, the shaped catalyst body may have a crushing strength of 300 to 3000 N. In some examples, the shaped catalyst body may have one or more holes therein. In some implementations, the shaped catalyst body may have a cylinder shape with a diameter of 2 to 25 mm and a height of 1 to 30 mm.

According to another aspect, a method for manufacturing a shaped catalyst body for manufacturing a synthetic gas includes: forming a shaped carrier body by shaping a carrier powder, depositing a metal active particle on the shaped carrier body using an atomic layer deposition process, and forming a metal oxide on at least a portion of (i) the shaped carrier body and (ii) the metal active particle.

Implementations according to this aspect can include one or more of the following features. For example, forming the shaped carrier body may include apply a compressive strength of 1 to 20 KN to the carrier powder. After forming the shaped carrier body, the shaped carrier body may be heated to a temperature of 800 to 1500° C.

In some examples, depositing the metal active particle may include injecting a metal active particle precursor and heating to a temperature of 100 to 350° C.

In some examples, depositing the metal active particle may include repeating, 100 to 1000 times, (i) injecting a metal active particle precursor, (ii) heating to a temperature of 100 to 350° C., and (iii) performing purging.

In some cases, forming the metal oxide coating layer may include injecting hydrogen and heating to a temperature of 600 to 1000° C.

According to another aspect, a method for manufacturing a synthetic gas includes injecting a reaction gas and an oxidizing agent such that the reaction gas and the oxidizing agent come into contact with the shaped catalyst body described above, and reforming the reaction gas through an endothermic reaction to manufacture the synthetic gas.

Implementations according to this aspect can include one or more of the following features. For example, the reaction gas may include one or more of C1 to C20 alkane, C1 to C20 alkene, C1 to C20 alkyne, ammonia (NH₃), formaldehyde (HCO₂H), and methanol (CH₃OH).

In some examples, the oxidizing agent may include one or more of carbon dioxide (CO₂), steam (H₂O), and oxygen (O₂).

In some implementations, the shaped catalyst body for manufacturing a synthetic gas can be manufactured in various shapes and has a structure that facilitates heat and mass transfer, thereby expanding the reaction surface area and preventing pressure drop.

In some implementations, the shaped catalyst body for manufacturing a synthetic gas has a high crushing strength, making it possible to prevent flow resistance from occurring due to crushing of the shaped catalyst body.

In some implementations, the catalyst activity can be increased even when a small amount of active metal is used.

In some implementations, reduction of active metal particles prior to a reaction and formation of metal oxide can be performed using the same process, thereby reducing process cost.

### BRIEF DESCRIPTION OF THE DRAWINGS

FIG. 1 is a diagram schematically showing a cross-section of an example of a shaped catalyst body for manufacturing a synthetic gas.

FIG. 2 is a diagram schematically showing an example of a shaped catalyst body for manufacturing a synthetic gas.

FIG. 3 is a photograph of Example 1 analyzed using transmission electron microscopy (TEM).

FIG. 4 is a graph showing a particle diameter distribution of Ni in a shaped catalyst body prepared in Example 1.

FIG. 5 is a photograph of Example 2 analyzed using transmission electron microscopy (TEM).

FIG. 6 is a graph showing a particle diameter distribution of Ni in a shaped catalyst body prepared in Example 2.

FIG. 7 is a photograph of Comparative Example 1 analyzed using transmission electron microscopy (TEM).

FIG. 8 is a graph showing a particle diameter distribution of Ni in a shaped catalyst body prepared in Comparative Example 1.

FIG. 9 is a photograph of the shaped catalyst body prepared in Example 1, analyzed using transmission electron microscopy (TEM) after reduction.

FIG. 10 is a graph showing results of X-ray absorption fine structure (XAFS) analysis of the shaped catalyst body prepared in Example 1 after reduction.

FIG. 11 is an image of the shaped catalyst body prepared in Example 1, analyzed by HAADF (High-angle-annular dark-field)-STEM after reduction.

FIGS. 12 and 13 are images of the shaped catalyst body prepared in Example 1, analyzed using fast Fourier transform (FFT) after reduction.

FIG. 14 is a graph showing results of a catalyst activity test conducted on shaped catalyst bodies prepared in Examples 1 and 2 and Comparative Examples 1 and 2.

### DETAILED DESCRIPTION

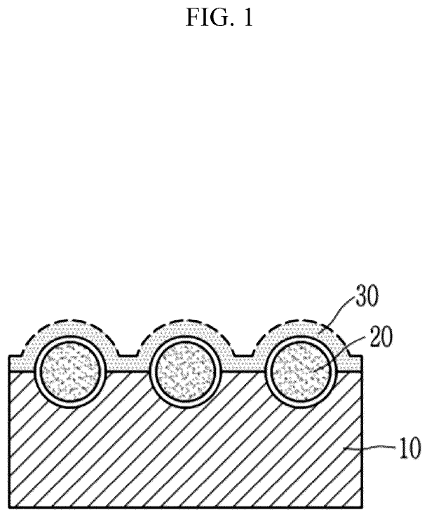

FIG. 1 is a diagram schematically showing a cross-section of an example of a shaped catalyst body 100 for manufacturing a synthetic gas.

In some implementations, as shown in FIG. 1, the shaped catalyst body 100 includes a shaped carrier body 10 and metal active particles 20 supported on the shaped carrier body. A metal oxide coating layer 30 is provided on at least a portion of surfaces of the shaped carrier body 10 and the metal active particles 20.

The configuration of the shaped catalyst body 100 will be described in detail.

In some implementations, the shaped carrier body includes alumina (Al₂O₃) and boehmite (AlOOH). An aspect of the present disclosure is to manufacture a shaped body by shaping a carrier powder, and when shaping the carrier powder, cracks may occur if boehmite is not included. In some examples, where boehmite is appropriately included, formability can be improved. Boehmite may be included in an amount of 10 to 30 parts by weight relative to 100 parts by weight of alumina. If boehmite is not included appropriately, it may be difficult to obtain sufficient formability. If boehmite is excessively included, the catalyst production cost may increase. Alumina may be present in an alpha-alumina form.

The metal active particle 20 is a component having activity in converting a reaction gas to produce a synthetic gas and supported on the shaped carrier body 10. For example, the metal active particle may include one or more of nickel (Ni), cobalt (Co), rhodium (Rh), ruthenium (Ru), iridium (Ir), palladium (Pd), platinum (Pt), gold (Au), and iron (Fe). More specifically, nickel (Ni) may be included.

In some implementations, an average particle diameter of the metal active particles 20 may be 5 to 30 nm. If the average particle diameter of the metal active particles 20 is too small, the manufacturing reproducibility may decrease depending on the manufacturing process conditions and the like. If the average particle diameter of the metal active particles 20 is too large, the metal may be sintered during a reaction, thereby reducing the catalyst activity. More specifically, the average particle diameter of the metal active particles 20 may be 8 to 20 nm. The average particle diameter of the metal active particles 20 may be obtained from a magnified image of a cross-section of the shaped catalyst body taken using transmission electron microscopy or the like, and the particle diameter may refer to the equivalent circular diameter. The average particle diameter refers to an average based on the number of metal active particles 20.

In some implementations, a particle diameter standard deviation of the metal active particles 20 may be 0.1 to 10 nm. A small particle diameter standard deviation indicates that the particle diameters of the metal active particles 20 are formed uniformly, which can be advantageous for catalyst activity. More specifically, the particle diameter standard deviation of the metal active particles 20 may be 0.5 to 3 nm. The particle diameter standard deviation of the metal active particles 20 may be obtained from a magnified image of a cross-section of the shaped catalyst body taken using transmission electron microscopy or the like, and the particle diameter may refer to the equivalent circular diameter.

The metal oxide coating layer 30 is present on at least a portion of surfaces of the metal active particles and the shaped carrier body, thereby ensuring the durability of the metal active particles 20.

The metal oxide coating layer 30 may include a metal component of the shaped carrier body 10 and a metal component of the metal active particles 20. For example, when the shaped carrier body 10 includes alumina (Al₂O₃) and the metal active particles 20 include Ni, the metal oxide coating layer 30 may include nickel aluminate (NiAl₂O₄). In some implementations, in the shaped catalyst body 100, the metal active particles 20 are supported on the shaped carrier body 10 using an atomic layer deposition process, and then the metal oxide coating layer 30 is formed on the surface of the shaped carrier body 10 during a reduction process. In this process, some of the metal components in the metal active particles 20 and the shaped carrier body 10 combine to form the metal oxide coating layer 30.

Specifically, the metal oxide coating layer 30 may include one or more of alumina (Al₂O₃), magnesium aluminate (MgAl₂O₄), calcium aluminate (CaAl₂O₄), and nickel aluminate (NiAl₂O₄). More specifically, the metal oxide coating layer 30 may include nickel aluminate (NiAl₂O₄). An average thickness of the metal oxide coating layer 30 may be 2 to 10 nm. If the thickness of the metal oxide coating layer 30 is too thin, the metal active particles 20 may be easily sintered, and if the thickness of the metal oxide coating layer 30 is too thick, the mass transfer resistance may increase, thereby inhibiting the catalyst activity. More specifically, the average thickness of the metal oxide coating layer 30 may be 3 to 7 nm. The average thickness may be obtained from a magnified image of a cross-section of the shaped catalyst body taken using transmission electron microscopy or the like.

The metal component of the metal active particles 20 may be included in an amount of 0.1 to 2 wt % relative to a total 100 wt % of the shaped catalyst body 100 including the shaped carrier body 10, the metal active particles 20, and the metal oxide coating layer 30. For example, when the metal active particles 20 include Ni, Ni in the shaped catalyst body 100 may be 0.1 to 2 wt %. If the amount of the metal component is too small, an amount of active metal to convert a reaction gas may be insufficient, leading to an increase in unreacted substances. On the other hand, if the amount of the metal component is too large, the specific surface area of the metal active particles 20 may decrease, leading to a reduction in reaction efficiency. More specifically, the metal component in the shaped catalyst body 100 may be 0.15 to 1.5 wt %. The metal component may be measured using inductively coupled plasma (ICP).

A specific surface area of the shaped catalyst body 100 may be 0.1 to 30 m²/g, an average pore diameter may be 40 to 200 nm, and a porosity may be 40 to 90%.

If the specific surface area of the shaped catalyst body 100 is too small, the Ni particles may be sintered during the reaction, resulting in a reduction in performance, and conversely, if the specific surface area is too large, the shaped catalyst body may not have appropriate crushing strength and may break easily. More specifically, the specific surface area of the shaped catalyst body 100 may be 1 to 15 m²/g

The specific surface area may be analyzed using Brunauer-Emmett-Teller (BET). More specifically, the specific surface area may be measured by, while adsorbing and desorbing nitrogen, measuring the amount of nitrogen.

If the average pore diameter of the shaped catalyst body 100 is too small, Ni particles may not be dispersed in pores, and conversely, if the average pore diameter is too large, a degree of dispersion of Ni particles may decrease, making them easily sintered during the reaction. More specifically, the average pore diameter of the shaped catalyst body 100 may be 80 to 150 nm. The average pore diameter may be measured using a porosity analyzer (porosimeter).

If the porosity of the shaped catalyst body 100 is too low, the degree of dispersion of Ni particles may decrease, and conversely, if the porosity is too high, the shaped catalyst body 100 may not have appropriate crushing strength and may break easily. More specifically, the porosity of the shaped catalyst body 100 may be 60 to 85%. The porosity may be measured using a porosity analyzer (porosimeter).

The shaped catalyst body 100 may have a crushing strength of 300 to 3000 N. The shaped catalyst body 100 may be easily broken into fragments due to mechanical impact when loaded into a reactor, thermal expansion and contraction during a temperature rise to a reforming reaction temperature (600° C. or higher) and shutdown after a reaction, and or coke formation. Small fragments resulting from such phenomena may fill gaps between the shaped catalyst bodies 100 and also accumulate at the bottom of the reactor, potentially causing flow resistance to a reformed gas. If the crushing strength is too high, excessive energy may be consumed during shaping, or a surface area where active metal can be supported may decrease, resulting in inefficiency. More specifically, the shaped catalyst body 100 may have a crushing strength of 400 to 1000 N. The crushing strength may be measured by compressive strength using a universal testing machine.

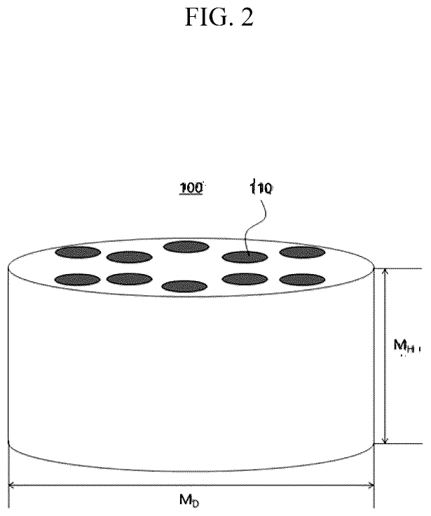

FIG. 2 is a diagram schematically showing the shaped catalyst body 100 for manufacturing a synthetic gas. A shape of the shaped catalyst body 100 may be substantially the same as a shape of the shaped carrier body 10 manufactured by shaping the carrier powder.

The shape of the shaped catalyst body 100 is not particularly limited, but may be, for example, a sphere, cylinder, dome-shaped cylinder, or petal. Additionally, the shaped catalyst body 100 may have one or more holes inside so as to be advantageous for pressure drop in the reactor. The holes are intentionally formed during the shaping process of the shaped carrier body 10, have a diameter of 1 mm or greater, and are distinct from pores.

More specifically, the shaped catalyst body 100 may have a cylinder shape with a diameter (M_{D}) of 2 to 25 mm and a height (M_{H}) of 1 to 30 mm. FIG. 2 illustrates the shaped catalyst body 100 having a cylinder shape with 10 (ten) holes 110. Specifically, the number of holes 210 may be 3 to 10. In addition, the shaped catalyst body 100 may have a cylinder shape with a diameter (M_{D}) of 3 to 20 mm and a height (M_{H}) of 3 to 20 mm.

A method for manufacturing a shaped catalyst body 100 for manufacturing a synthetic gas according to an aspect includes steps of shaping a carrier powder to manufacture a shaped carrier body 10; supporting metal active particles 20 on the shaped carrier body 10 using an atomic layer deposition process; and forming a metal oxide coating layer on at least a portion of surfaces of the shaped carrier body and the metal active particles.

A carrier powder is shaped to manufacture a shaped carrier body 10. For example, after mixing a binder with the carrier powder, the mixture is atomized and put into a rotary continuous tableting machine to shape the mixture into a desired shape of a shaped body. In this case, the compressive strength may be 1 to 20 kN. For instance, compressive force of 1 to 20 kN may be applied to the mixture of the carrier powder and the binder. More specifically, a compressive strength of 2 to 5 kN may be used. A rotation speed of a rotor may be 5 to 30 RPM. Since the shape of the shaped carrier body 10 has been described in relation to the shaped catalyst body 100, redundant description is omitted.

The type of carrier has been described in relation to the shaped carrier body 10. Specifically, when the carrier includes alumina and boehmite, boehmite may be mixed with alumina by using a dry impregnation method (Incipient Wetness Impregnation), and compressed to manufacture a shaped body. In this case, a binder may be added in an amount of 2 to 5 wt % relative to the total carrier for tableting.

After the step of manufacturing the shaped carrier body 10, the shaped carrier body 10 may be fired at a temperature of 800 to 1500° C. If the firing temperature is too low, the strength of the shaped catalyst body 100 may be lowered. If the sintering temperature is too high, no additional increase in strength can be expected, and problems with catalyst activity may occur. More specifically, the shaped carrier body may be fired at a temperature of 1000 to 1300° C. In this case, the firing time may range from 10 to 300 minutes. More specifically, the firing time may range from 60 to 240 minutes. A temperature increase rate may range from 1 to 10° C./min.

The metal active particles 20 are supported on the shaped carrier body 10 using an atomic layer deposition process. Since the types of metal active particles 20 have been described above, redundant descriptions are omitted.

The step of supporting the metal active particles 20 by the atomic layer deposition process may involve injecting a metal active particle precursor and performing heating to a temperature of 100 to 350° C. The metal active particle precursor can be used without particular limitations as long as it is a material that decomposes when heated to a temperature of 100 to 350° C. and enables metal active particles to be supported on the surface of the shaped carrier body 10.

Specifically, the metal active particle precursor may include one or more of nickel 1-dimethylamino-2-methyl-2-butoxide, bis(ethylcyclopentadienyl) nickel, bis(cyclopentadienyl) nickel, allyl(cyclopentadienyl)nickel(II), bis(methylcyclopentadienyl)nickel(II), bis(N,N′-ditertialbutylacetamidinate)nickel, and bis(alkyl-alkane-imidamidato)nickel. The metal active particle precursor may be performed in a short period of time, such as less than 30 seconds.

Before injecting the metal active particle precursor, a pretreatment may be performed in a vacuum atmosphere to remove moisture within the shaped carrier body 10 and internal air within the pores.

After injecting the metal active particle precursor, purging may be performed in an inert gas atmosphere. The purging time may be 30 seconds or longer.

In this case, the step of supporting the metal active particles may involve repeating the steps of injecting a metal active particle precursor, performing heating to a temperature of 100 to 350° C., and performing purging, 100 to 1,000 times. By repeatedly performing injection of the metal active particle precursor and purging, the particle diameters of the metal active particles 20 can be controlled.

Next, a reduction process is performed before manufacturing a synthetic gas to form a metal oxide coating layer 30 on at least a portion of surfaces of the shaped carrier body 10 and the metal active particles 20. Since the metal oxide coating layer 30 has been described above, redundant description is omitted.

The step of forming the metal oxide coating layer may involve injecting hydrogen and performing heating to a temperature of 600 to 1000° C. By appropriately controlling the temperature, further growth of the metal active particles can be suppressed, and the crushing strength can be improved.

In this case, the metal components of the shaped carrier body 10 and the metal active particles 20 are formed into metal oxides. For example, when the shaped carrier body 10 includes alumina and the metal active particles 20 include Ni, the metal oxide coating layer 30 may include nickel aluminate (NiAl₂O₄).

A method for manufacturing a synthetic gas includes injecting a reaction gas and an oxidizing agent so that they come into contact with the shaped catalyst body for manufacturing a synthetic gas described above, and reforming the reaction gas through an endothermic reaction to manufacture a synthetic gas.

As an example, the method for manufacturing a synthetic gas is a method of converting methane and steam, which are raw materials for existing steam reforming, into a synthetic gas by adding carbon dioxide, which is a major greenhouse gas, to methane and steam, and for example, may perform combined steam and carbon dioxide reforming of methane expressed in Reaction Scheme 1 below to manufacture a synthetic gas including carbon monoxide and hydrogen.

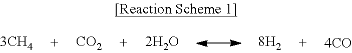

The reaction gas may include C1 to C20 alkane, C1 to C20 alkene, C1 to C20 alkyne, ammonia (NH₃), formaldehyde (HCO₂H), methanol (CH₃OH), or a combination thereof.

The oxidizing agent may include carbon dioxide (CO₂), steam (H₂O), oxygen (O₂), or a combination thereof.

As an example, the reaction gas may include methane, and carbon dioxide and water as the oxidizing agent, and in this case, the synthetic gas may include hydrogen and carbon monoxide. As an example, water may be included in the reaction gas in the form of steam.

The synthetic gas manufacturing method is to supply the reaction gas by adjusting the molar ratio in order to obtain a composition for the synthetic gas.

The reaction gas may include methane and the oxidizing agent (carbon dioxide and water) in a molar ratio of 1:1 to 1:3, for example, 1:1.2 to 1:2.

If the molar ratio of the oxidizing agent is less than 1, the conversion rate of methane will decrease and the amount of carbon deposition will increase, which may cause deactivation of the catalyst. If the molar ratio exceeds 3, the conversion rate of carbon dioxide will decrease and the surface of the catalytically active material will be oxidized, which may reduce an amount of hydrogen generated. The molar ratio of methane and oxidizing agent of 1:1.2 to 1:2 may be an optimal ratio, considering the conversion rate of the reaction gas, a ratio of H2/CO in the product gas, and the amount of carbon deposition.

The oxidizing agent may include carbon dioxide and water in a molar ratio of 0.2:1.5 to 1.2:0.2. When the molar ratio of water exceeds 1.5, deactivation of the catalyst may be promoted due to unreacted residual steam.

Note that in the case of combined reforming, the reaction gas may further include nitrogen along with methane, carbon dioxide, and water. Nitrogen may be included in a molar ratio of 1:1 to 1:3 relative to methane. Nitrogen may be used as a diluent to reduce the temperature fluctuation of the catalyst layer during the reaction.

The reaction gas may be supplied at a space velocity of 500/h to 20000/h, for example 1000/h to 10000/h. The supply rate of the reaction gas may be increased proportionally depending on the size of the combined reforming reactor and the capacity of the catalyst.

The reaction temperature and pressure for combined reforming may be appropriately adjusted depending on the composition of the required synthetic gas. For example, the temperature condition for the combined reforming reaction may be 600° C. to 1000° C., for example, 650° C. to 900° C., or 800° C. to 950° C. If the reaction temperature is lower than 600° C., the conversion rate of carbon dioxide is significantly lowered and CO₂ may be rather generated, and if the reaction temperature exceeds 1000° C., the heat energy is consumed inefficiently, which may cause thermal deactivation of the catalyst.

Additionally, the pressure condition for the combined reforming reaction may be, for example, 0.5 atm to 20 atm, for example, 1 atm to 10 atm. If the reaction pressure exceeds 20 atm, the conversion rate of reaction gases may decrease, and the ratio of H₂/CO may vary.

According to the method for manufacturing a synthetic gas using a catalyst, the conversion rate of methane and/or carbon dioxide relative to the reaction gas may be 30 mol % to 99.9 mol %, and may be stable against carbon deposition at 900° C. for up to 200 hours.

Below, specific examples of the disclosure are presented. However, the examples described below are only for illustrating or describing the disclosure in detail and should not be construed as limiting the scope of the present disclosure.

### Example: Preparation of Shaped Catalyst Body

1) Preparation of Shaped Carrier body

8 g of commercial alumina (Al₂O₃, Sasol, HP14-150) and 2 g of boehmite (AlOOH) were mixed with each other in a solid state. Deionized water was added in an amount of 10 wt % relative to the boehmite solid content, which was then stirred for 1 hour. After the stirring, the mixture was dried at 100° C. for 4 hours in an air atmosphere. In addition, for tableting, a binder (Al₂O₃ sol) was added in an amount of 5 wt % relative to the solid content. After adding the binder, it was dried at 100° C. for 8 hours. After drying, the powder was atomized using a high-shear pulverizer. Before putting the powder into the tableting equipment, deionized water was added to adjust the moisture content to 10 wt %. The powder with adjusted moisture content was put into a rotary continuous tableting machine through a hopper and tableted using a tableting pressure of 3 kN, and the rotation speed of the rotor was set to 20 RPM to prepare the final shaped carrier body. Thereafter, firing was performed at 1200° C. for 1 hour (temperature increase rate 5° C./min.) and for 2 hours (temperature increase rate 2° C./min.) in an air atmosphere, resulting in preparation of a shaped carrier body.

### 2) Supporting Active Metal Particle

The shaped carrier body prepared in the above-described step was cleaned to remove surface residual foreign substances and alumina in powder form. About 40 g of the prepared shaped carrier body was put into an ALD reactor, and moisture and air inside the pores were removed through a pretreatment at 150° C. for 30 min in a vacuum atmosphere. Then, while maintaining the heating at 150° C., internal purge (Ar purge, 1 minute) was performed, nickel 1-dimethylamino-2-methyl-2-butoxide precursor heated to 95° C. was injected and maintained for 15 seconds, and then internal purge was performed. The precursor injection and the purge were repeated 100 times (Example 1) and 300 times (Example 2), respectively.

### Comparative Example 1

8 g of commercial alumina (Al₂O₃, Sasol, HP14-150) and 2 g of boehmite (AlOOH) were mixed with each other in a solid state. Deionized water was added in an amount of 10 wt % relative to the boehmite solid content, which was then stirred for 1 hour. After stirring, a drying process was performed at 100° C. for 4 hours in an air atmosphere, resulting in preparation of the carrier powder.

10 g of the prepared carrier powder and 2 g of nickel nitrate were mixed with each other in a solid state. A small amount of deionized water was added to support nickel nitrate. After stirring was completed, a drying process was performed at a temperature of 100° C. for 10 hours in an air atmosphere.

Then, an overlayer coating was performed with metal oxide. 0.18 g of aluminum isopropoxide was added to 10 g of the powder prepared according to the above method, which was then stirred for 30 minutes in a solid state. In some examples, an overlayer coating was prepared using a melt infiltration process.

For tableting of powder catalyst, a binder (Al₂O₃ sol) was added in an amount of 5 wt % relative to the solid content. After adding the additive, the mixture was dried at 100° C. for 8 hours. A shaped product was prepared and fired in the same manner as in the Examples.

Ni Content Analysis: To confirm the composition of the prepared shaped catalyst body, the amounts of catalytically active metal and metal oxide were measured using inductively coupled plasma (ICP), and the results are shown in Table 1.

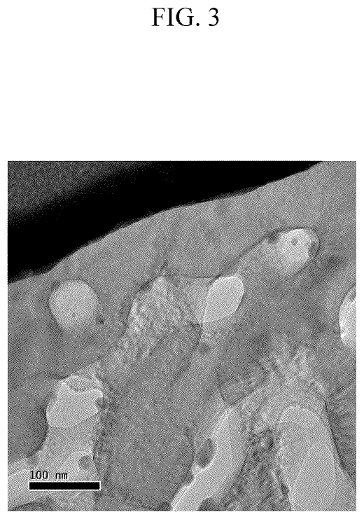

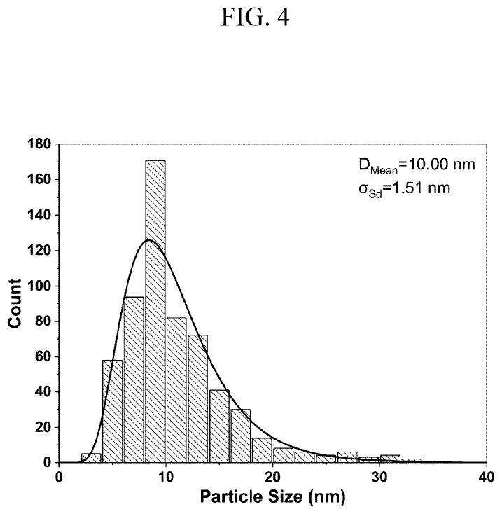

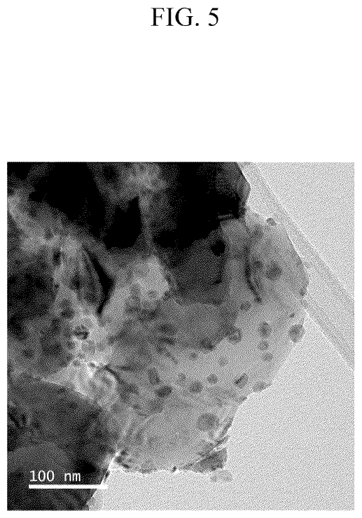

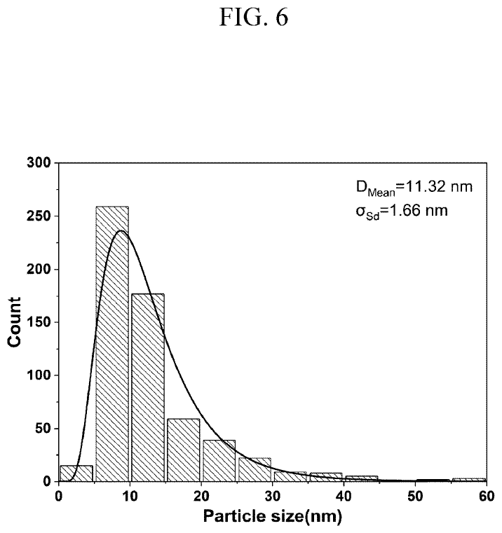

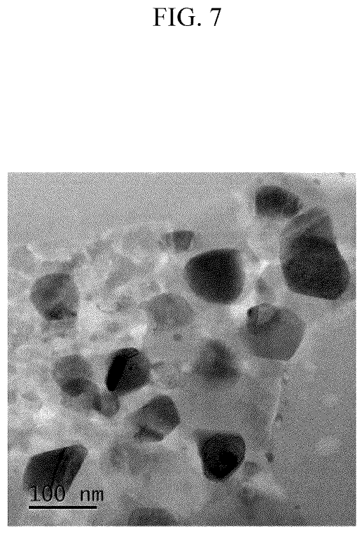

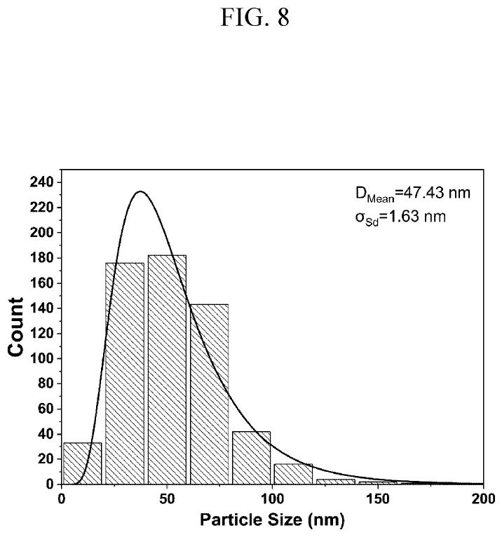

Shape Analysis of Shaped Catalyst Body: To analyze the shape of the prepared shaped catalyst body, a transmission electron microscope (TEM) was used. The results are summarized in FIG. 3 to 8 and Table 1. As shown in FIG. 3 to 8, in Examples 1 and 2, the average particle diameter of the metal active particles is appropriately formed, and the size distribution of the metal active particles is also appropriately formed. In Comparative Example 1, coarse metal active particles are formed compared to Examples 1 and 2.

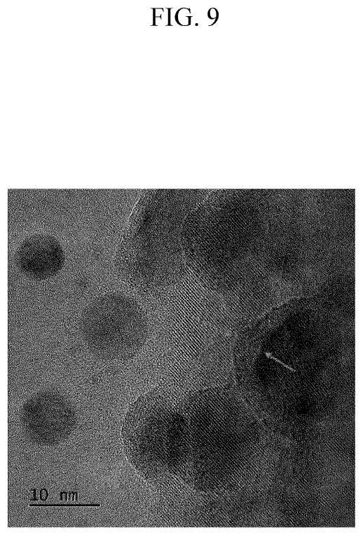

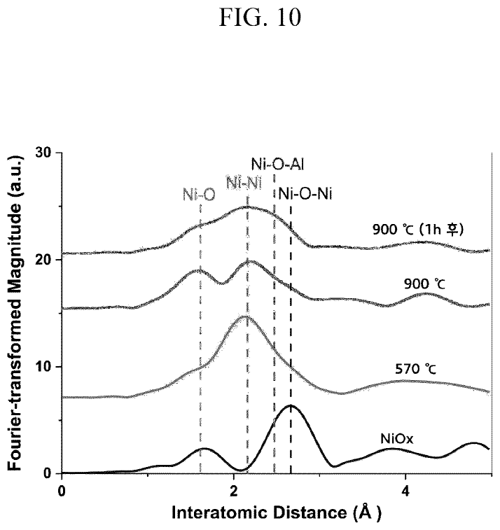

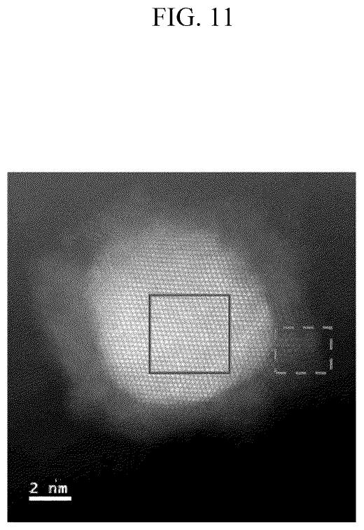

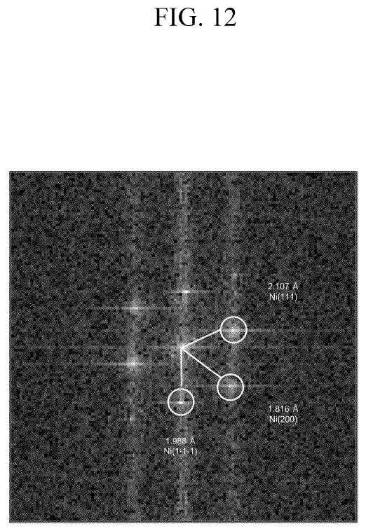

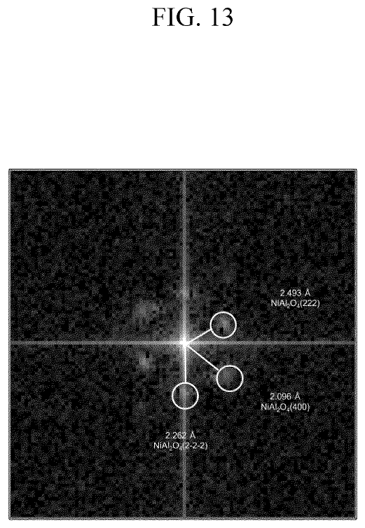

Analysis of Metal Oxide Coating Layer: A photograph of the shaped catalyst body prepared in Example 1, analyzed by transmission electron microscopy (TEM), is shown in FIG. 9. As shown in FIG. 9, a metal oxide coating layer is formed around Ni particles. FIG. 10 is a graph showing results of X-ray absorption fine structure (XAFS) analysis of the shaped catalyst body prepared in Example 1 during the reduction process in a hydrogen atmosphere and at a raised temperature of 900° C. NiO is reduced to Ni up to 570° C. and Ni—O—Al bonds appear when the reducing atmosphere is maintained at 900° C. for 1 hour. FIG. 11 is an image of the shaped catalyst body prepared in Example 1, analyzed by HAADF (High-angle-annular dark-field)-STEM after reduction. As shown in FIG. 12, the metal active particle portions matches the Ni crystal plane directions, and as shown in FIG. 13, the metal oxide coating layer matches the crystal plane directions of NiAl₂O₄.

Pore Analysis of Shaped Catalyst Body: To analyze the pore structure of the catalyst, the BET (Brunauer-Emmett-Teller) specific surface area was analyzed. To remove moisture and surface-adsorbed substances, the powder catalyst was subjected to a heat treatment process continuously at 90° C. for 1 h and 350° C. for 4 h in a vacuum state. Then, nitrogen was adsorbed and desorbed at a temperature of −196° C. and the amount thereof was measured to determine the specific surface area of the powder catalyst, which is shown in Table 1. The average pore diameter and porosity were analyzed using a porosity analyzer (porosimeter), and the results are shown in Table 1.

Crushing Strength Measurement: To analyze the strength of the shaped catalyst body, the crushing strength was measured using a compression testing machine. The crushing strength was measured using a universal testing machine Unitech-M, and the results are shown in Table 1.

TABLE 1

| | | | Particle | Material | | |
|---|---|---|---|---|---|---|
| | | Ni | diameter | of metal | Final heat | |
| | Ni | particle | standard | oxide | treatment | Crushing |
| | content | diameter | deviation | coating | temperature | strength |
| | (wt %) | (nm) | (nm) | layer | (° C.) | (N) |
| Example 1 | 0.1 | 10.00 | 1.51 | NiAl₂O₄ | 900 | 522 |
| Example 2 | 0.3 | 11.32 | 1.66 | NiAl₂O₄ | 900 | 522 |
| Comparative | 12 | 47.43 | 1.63 | Al₂O₃ | 1200 | 853 |
| Example 1 | | | | | | |
| Comparative | 12 | 12 | — | | | |
| Example 2 | | | | | | |
| (Commercial Ni | | | | | | |
| catalyst) | | | | | | |

As shown in Table 1, in Examples 1 and 2, the average particle diameters of Ni particles are small and the Ni contents are also low.

### Experimental Example: Production of Synthetic Gas from Reforming Raw Material

Synthetic gases were produced using the shaped catalyst bodies prepared in Example 1, Example 2, Comparative Example 1, and Comparative Example 2.

The combined reforming was performed using methane as the reaction gas and carbon dioxide and steam as the oxidizing agent. The shaped catalyst body was fixed at 6 cm in the 1 in. reactor, the temperature was raised to 900° C. in a hydrogen atmosphere, and reduction was performed for 2 hours. Then, CH₄, CO₂, and H₂O were injected at a ratio of CH₄:CO₂:H₂O=1:0.5:1 at a space velocity (SV) of 9000/h. The temperature was 900° C. and the pressure was 1 bar.

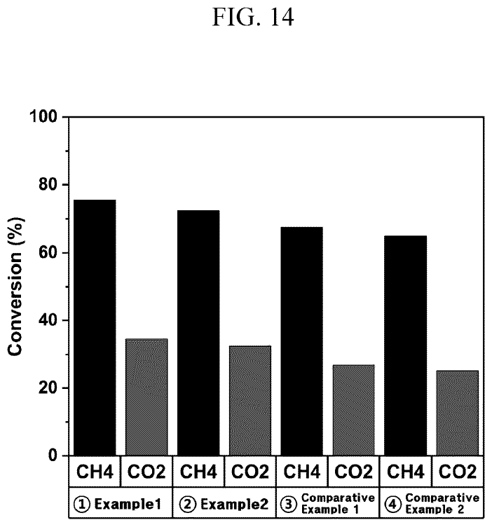

The catalyst activity is shown in FIG. 14.

As shown in FIG. 14, Examples 1 and 2, in which the particle diameter of the active metal particles was appropriately formed using the atomic layer deposition process, exhibit superior catalyst activity compared to Comparative Examples 1 and 2. In Example 1, the CH4 conversion rate was 75.6%, and the CO2 conversion rate was 34.5%, despite the Ni content being only 1/120 of that in Comparative Example 1. In Example 2, the CH4 conversion rate was 72.4%, and the CO2 conversion rate was 32.4%, despite the Ni content being about 1/40 of that in Comparative Example 1. Example 1 with smaller Ni particle size is superior in performance despite the Ni content being lower. In Comparative Example 1 in which the Ni-based powder catalyst having a metal oxide coating layer was extruded, the CH₄ conversion rate was 67.5%, and the CO₂ conversion rate was 26.8%, and better performance than the commercial catalyst in Comparative Example 2 was exhibited. This indicates that the presence or absence of a metal oxide coating layer affects the sintering rate of Ni particles during the reaction.

In addition, for Example 1, long-term durability was evaluated by producing synthetic gas as described above, but performing the reaction at a catalyst layer thickness of 3.4 cm and a space velocity of 9000/h for 200 h. This is summarized in Table 2 below.

TABLE 2

| | | |
|---|---|---|
| Space velocity 9000/h | CH₄ | CO₂ |

| | | | | |
|---|---|---|---|---|
| Time on Stream (h) | 1 | 200 | 1 | 200 |
| Conversion rate (%) | 86.3 | 80.3 | 52.5 | 46.3 |

As shown in Table 2, despite the long-term reaction for 200 h under the harsh conditions of the space velocity of 9000/h, the conversion rate decreased by only about 6%. The example indicates the durability of the shaped catalyst body.

What is claimed is:

1. A shaped catalyst body for manufacturing a synthetic gas, comprising:
a shaped carrier body;
a plurality of metal active particles that are supported by the shaped carrier body, wherein an average particle diameter of the plurality of metal active particles is 5 to 30 nm; and
a metal oxide coating layer that is disposed on at least a portion of (i) the plurality of metal active particles and (ii) the shaped carrier body.

2. The shaped catalyst body of claim 1, wherein the shaped carrier body comprises alumina and boehmite.

3. The shaped catalyst body of claim 1, wherein the plurality of metal active particles comprises one or more of nickel (Ni), cobalt (Co), rhodium (Rh), ruthenium (Ru), iridium (Ir), palladium (Pd), platinum (Pt), gold (Au), and iron (Fe).

4. The shaped catalyst body of claim 1, wherein the metal oxide coating layer comprises a metal component of the shaped carrier body and a metal component of the plurality of metal active particles.

5. The shaped catalyst body of claim 1, wherein the metal oxide coating layer comprises one or more of alumina (Al₂O₃), magnesium aluminate (MgAl₂O₄), calcium aluminate (CaAl₂O₄), and nickel aluminate (NiAl₂O₄).

6. The shaped catalyst body of claim 1, wherein an average thickness of the metal oxide coating layer is 2 to 10 nm.

7. The shaped catalyst body of claim 1, wherein a metal component of the plurality of metal active particles is 0.1 to 2 wt % relative to a total 100 wt % of the shaped catalyst body.

8. The shaped catalyst body of claim 1, wherein a specific surface area of the shaped catalyst body is 0.1 to 30 m²/g, and a porosity of the shaped catalyst body is 40 to 90%, and
wherein an average pore diameter of the shaped catalyst body is 40 to 200 nm.

9. The shaped catalyst body of claim 1, wherein the shaped catalyst body has a crushing strength of 300 to 3000 N.

10. The shaped catalyst body of claim 1, wherein the shaped catalyst body has one or more holes therein.

11. The shaped catalyst body of claim 1, wherein the shaped catalyst body has a cylinder shape with a diameter of 2 mm to 25 mm and a height of 1 mm to 30 mm.

12. A method for manufacturing a shaped catalyst body for manufacturing a synthetic gas, comprising:
forming a shaped carrier body by shaping a carrier powder;
depositing a metal active particle on the shaped carrier body using an atomic layer deposition process; and
forming a metal oxide coating layer on at least a portion of (i) the shaped carrier body and (ii) the metal active particle.

13. The method of claim 12, wherein forming the shaped carrier body comprises applying a compressive strength of 1 to 20 kN to the carrier powder.

14. The method of claim 12, further comprising:
after forming the shaped carrier body, heating the shaped carrier body to a temperature of 800 to 1500° C.

15. The method of claim 12, wherein depositing the metal active particle comprises injecting a metal active particle precursor and heating to a temperature of 100 to 350° C.

16. The method of claim 12, wherein depositing the metal active particle comprises repeating, 100 to 1,000 times, (i) injecting a metal active particle precursor, (ii) heating to a temperature of 100 to 350° C., and (iii) performing purging.

17. The method of claim 12, wherein forming the metal oxide coating layer comprises injecting hydrogen and heating to a temperature of 600 to 1000° C.

18. A method for manufacturing the synthetic gas, comprising:
injecting a reaction gas and an oxidizing agent such that the reaction gas and the oxidizing agent come into contact with the shaped catalyst body of claim 1; and
reforming the reaction gas through an endothermic reaction to manufacture the synthetic gas.

19. The method of claim 18, wherein the reaction gas comprises one or more of C1 to C20 alkane, C1 to C20 alkene, C1 to C20 alkyne, ammonia (NH₃), formaldehyde (HCO₂H), and methanol (CH₃OH).

20. The method of claim 18, wherein the oxidizing agent comprises one or more of carbon dioxide (CO₂), steam (H₂O), and oxygen (O₂).
